(19) United States
(12) Patent Application Publication
(10) Pub. No.: US 2012/0209793 A1
(43) Pub. Date: Aug. 16, 2012

(54) Ideation Search Engine

(75) Inventor: Henry Minard Morris, Venice, CA (US)

(73) Assignee: Henry Minard Morris, JR., Venice, CA (US)

(21) Appl. No.: 13/209,415

(22) Filed: Aug. 14, 2011

Related U.S. Application Data
(60) Provisional application No. 61/375,117, filed on Aug. 19, 2010.

(51) Int. Cl. G06F 17/00; G06N 5/00

(52) U.S. Cl. 706/11; 706/45

(57) ABSTRACT

It is an object of the present invention to provide a system for measuring, valuing, assigning, processing and accessing emotional values for use in an idea generation, or ideation, search engine. This system may be applied to searching and matching between different entities, where an entity can be anything including websites, multimedia objects, products, people, places and ideas. According to another aspect of the present invention, a computer system for codifying human emotion into a machine readable language is disclosed. The computer system comprises an emotion preference server, an enterprise system, an end-user system and a search and match engine.

### CROSS-REFERENCE TO RELATED APPLICATIONS

Not Applicable

### FEDERALLY SPONSORED RESEARCH OR DEVELOPMENT

Not Applicable

### SEQUENCE LISTING OR COMPUTER PROGRAM

Not Applicable

### FIELD OF INVENTION

The present invention is related to a computerized search engine, and in particular an idea generation search engine.

### BACKGROUND OF THE INVENTION

A conventional Internet search engine uses a text string as the criteria to generate search results. It takes for granted that the user starts with some vague notion of what they are looking for and its purpose is to return Web-based multimedia content that is the most relevant to the user's query. But what if the user's mind is blank (i.e., lacking a text string) and they are wanting a way of generating ideas? Idea generation, or “ideation,” is a process of the brain that is less dependent on reason and logic than on creativity and feeling, and is an area for which the many powerful search engines of the Internet have yet to develop effective tools. For the purpose of ideation, the user's emotions are at least as important to the creative process as rational criteria. The conventional search engine does not provide a means of access to the user's emotions, nor does it provide a valuation system for emotions so as to return emotionally relevant results.

The 18th century Scottish philosopher David Hume famously remarked, “Reason is, and ought only to be, the slave of the passions.” That is, the function of reason is to work out how to achieve the goals endorsed by the emotions. Advertisers have known this for centuries: when making purchase choices, emotions are likely the primary deciding factor, while reason plays a secondary role as justifier of the choice. An ideation engine could be useful in many ways. As an example, eCommerce platforms such as Amazon.com® could benefit from ideation tools for such purposes as gift shopping to aid their users whose minds are blank and in need of help with generating relevant gift ideas. Conventional search engine functionality is inadequate for this purpose because it lacks a methodology for including emotion as a criterion in what is at least as much an intuitive, as it is a rational process.

There are three primary challenges to creating a search engine for ideation: 1. an input means allowing the user to communicate their emotional state of mind, 2. a system for emotionally valuing diverse entities or stimuli, including websites, multimedia objects, products, people, places and ideas, and 3. a calculus to return the most relevant stimuli. The last of these, the calculus, is easy because just like a conventional search engine, it's based on a mathematical equation. The difficulty comes in the first two: a way of allowing the user to express their emotional preferences (an emotion input form) that compliments the elegance of the conventional search engine text input form, and a way of classifying emotion that compliments the emotion input form.

Neuroscientists and philosophers disagree about the origins of emotions, and science has yet to create a widely accepted taxonomy. How we design and evaluate for emotions depends crucially on what we take emotions to be. So here are several prominent neuro-biological theories of emotion:
Rolls (1986). Emotion can be defined as states produced by reinforcing stimuli. The amygdala establishes the stimuli-reinforcement associations, the orbitofrontal cortex manage them, and the hypothalamus expresses the emotional state.
Pribam (1986). The whole brain is involved in emotional experience and expression. Each part of the brain is specifically responsible for the sensing and control of body and neural events. It is in this regulation of brain and body states that lay emotions. Regulation is achieved through both neural conduction, and neurochemical/hormonal actions.
Pankseep (1982). Emotions are ‘translimbic’ sensory-motor command (executive) systems.
Plutchik (1980). There are 8 primary states which can be conceived as pairs of opposites. Emotion serves an adaptive role in helping with survival issues, and primary emotions arise as a consequence of inadequacies between the organism and the sensory environment (including ‘internal senses’ such as thoughts). For the sake of an ideation engine, the most significant of Plutchik's ten postulates of psychoevolutionary theory are:
   5. There is a small number of basic, primary, or prototype emotions.
   6. All other emotions are mixed or derivative states; that is, they occur as combinations, mixtures, or compounds of the primary emotions.
   7. Primary emotions can be conceptualized in terms of pairs of polar opposites.
   8. Each emotion can exist in varying degrees of intensity or levels of arousal.
      Most theorists agree with Plutchik's postulate that there exist primary emotions, the mixture of which create what are perceived as secondary emotions. But there is wide disagreement in identifying the primary emotions:
Plutchik: acceptance, anger, anticipation, disgust, joy, despair, sadness, surprise
Arnold: anger, aversion, courage, dejection, desire, despair, hate, hope, love, sadness
Izard: anger, contempt, disgust, distress, despair, guilt, interest, joy, shame, surprise
Frijda: desire, happiness, interest, surprise, wonder, sorrow
Grey: rage and terror, anxiety, joy
Mowrer: pain, pleasure
Thompkins: anger, interest, contempt, disgust, distress, despair, joy, shame, surprise
Weiner & Graham: happiness, sadness

Prior art for the addition of emotions to search engine functionality is very limited and recent. The most similar patent, A Method and System for Computerized Searching and Matching Multimedia Objects Using Emotional Preference (U.S. Pat. No. 7,610,255, Alex Willcock, 2009) proposes a way of improving conventional search engine results by creating an emotional profile for each user via a series of survey questions, then filtering the original search engine results according to the profile, thereby delivering emotionally relevant results specific to each user. While this does add emotion to the search engine's functionality, it is limited in the following ways:
It applies a broad singular “emotion profile” that stays with a user rather than adjusting to the potentially varying emotional circumstances of each moment and situation, serving more as a profile of personality or temperament than one of emotions, which can change frequently and dramatically.
The emotion capturing means of input it uses is cumbersome and time consuming, not providing a comparably simple alternative to the conventional search engine text field.
It still assumes the user has a vague notion of what they are looking for, thus limiting it as a tool for ideation.
It does not provide a general solution for modeling emotion states: it relegates emotional valuation to a non-standard system of emotion representation that works only in very specific situations and can only be calibrated by trained psychological professionals.
Its design does not make any attempt at integrating the theories of affective computing, a severe limitation considering that technology's profound state of the art.

In order to effectively create a means of allowing the user to communicate their emotions to the search engine, it is helpful to begin with the branch of neuroscience that deals with the design of systems and devices that can recognize, interpret, process, and simulate human emotions. In Affective Computing, affect is often taken to be another kind of information—discrete units or states internal to an individual that can be transmitted from people to computational systems and back. Formative efforts at affective computing used a cognitive approach. While modern affective computing challenges the primacy of rationality in cognitivist accounts of human activity, at a deeper level it often relies on and reproduces the same information-processing model of cognition.

In contrast, a social, interactional approach to understanding cognition in human-computer interaction has emerged in the last twenty years. The recent emphasis on the importance of emotion for cognition further advances these arguments to look “beyond the cognitive” and to understand new aspects of human experience.

The interactional account of emotion, as argued by Boellstorff and Lindquist, is that “feelings are not substances to be discovered in our blood but social practices organized by stories that we both enact and tell.” The production and interpretation of emotion is social and cultural in origin.

So, current affective computing research looks at three things, and these are useful for creating an emotion input means. First, it expands on the ontological view of emotions as informational units that are internally constructed, viewing them as culturally grounded, dynamically experienced, and to some degree constructed in interaction. Second, as an interface paradigm, an interactional approach moves the focus from helping computers to better understand human emotion to helping people to understand and experience their own emotions. Finally, the interactional approach leads to new evaluation strategies for computing devices. Measures of success for such systems do not focus on whether the systems themselves deduce the “right” emotion but whether the systems encourage the user's awareness of their own emotions and those of others.

Next, in order to create a measurement system for emotions that compliments such an emotion input means, we turn to emotion simulator technology. Emotion simulators allow a computer to mimic human emotion by using some data model or algorithm. Emotion simulators comprise logic-based systems, analogic systems (SME, Copycat, and ACME), neural net systems (emotivate systems) and the dimensional AVC (arousal-valence-control) emotion model.

### Such Standardized Systems for the Measurement of Emotions Include:

The PAD Emotion Scales: This is a set of self-report scales based on a semantic differential technique. Participants in a test rate each stimulus (e.g. product). From these ratings a score on the three main dimensions of affect (pleasure, arousal and dominance) can be calculated. The companion software can also calculate a score for eight basic emotions and rank them from closest to the reported emotional state to furthest apart from this state. The basic experimental rationale for describing and measuring all possible human emotions in terms of the three basic emotion dimensions were first described by Mehrabian and Russell (1974). Prior art includes “A System for Modeling and Simulating Emotion States” (US Patent 2003/0028383 A1 Charles L. Guerin, 2003)
PrEmo: Respondents can report their emotions with the use of expressive cartoon animations. In the instrument, each of the 14 measured emotions is portrayed by an animation of dynamic facial, bodily, and vocal expressions. PrEmo can be used in internet surveys, formal interviews, and in qualitative interviews.
The Differential Emotions Scale (DES): This is a standardized instrument that reliably divides the individual's description of emotion experience into validated, discrete categories of emotion. The DES was formulated to gauge the emotional state of individuals at that specific point in time when they are responding to the instrument.
Geneva Emotions Wheel: A survey in which the respondent is asked to indicate the emotion they experience by choosing intensities for a single emotion or a blend of several emotions out of twenty distinct emotion families. The emotion families are arranged in a wheel shape with the axes being defined by two major appraisal dimensions, control and pleasantness. Five degrees of intensity are proposed, represented by circles of different sizes.

Consider what computers do in the most basic sense: they build abstract models, or digital analogies, using the laws of nature to help humans more effectively pursue their real world goals. For the sake of an ideation search engine, and considering the complex and multifarious scientific understanding of emotions, there is no need to define a complete ontology of emotions. Rather, what we need is an accurate analogy that will allow us to create a computational model of emotion, one capable of including affective computing's research areas: informational units that are internally constructed, culturally grounded, dynamically experienced, interactionally aiding people to experience their own emotions rather than the computers “understanding” of them, and encouraging emotional awareness rather than the “rightness” of a given emotion.

### BRIEF SUMMARY OF THE INVENTION

It is an object of the present invention to provide a system for measuring, valuing, assigning, processing and accessing emotional values for use in an ideation search engine. This system may be applied to searching and matching between different entities, where an entity can be anything including websites, multimedia objects, products, people, places and ideas.

Accordingly, the present invention uses a method of codifying human emotion into a machine-readable language by a computer application. This codification is based on the recognition of an analogous relationship between emotion and the additive color model of the visible light spectrum. Color has been found to be three-dimensional, which means that any three colors can be used to describe a color space as long as a combination of two of the colors cannot be used to produce the third. An additive color model involves light emitted directly from a source, and usually uses red, green and blue (RGB) light to produce the other colors. Combining all three primary colors in equal intensities produces white. Varying the luminosity of each color eventually reveals the full gamut of the entire color spectrum. To represent this numerically, any point in the RGB space can be described by the proportion of red, green, and blue in the color.

Plutchik's postulates of psychoevolutionary emotion theory state that there are a small number of primary emotions that when mixed together create all other emotions, that each of the primaries has a polar opposite and that each exists in varying degrees of intensity. The emotion-color analogy follows each of these postulates. The primary colors are analogous to the primary emotions. Given the most commonly agreed upon primary emotions among theorists, we will generalize them to be happiness, love and hope, because these most accurately fit the requirement that no combination of two can be used to produce the third. However, the embodiment can use any of the theorized primary emotions if future tests or varying circumstances show improved choices.

Creating a system of valuation for emotions in this way means that they can have a spatial, quantitative relationship to one another in the same way that colors can. This valuation, herein called an “emotion code,” can be mapped to a three-dimensional emotion graph, just as a color can be mapped to a three-dimensional RGB color graph. An entity then resides emotionally in a spatial relationship to other entities, emotionally closer to some and farther from others. Thus, the ideation engine can use a mathematical equation as part of its algorithm in determining an emotional relevancy factor for its results.

According to another aspect of the present invention, a computer system for codifying human emotion into a machine readable language is disclosed. The system comprises an emotion preference server, an enterprise system, an end-user system and a search and match engine. The preference server is configured to capture the emotional preferences from the user and generate emotion codes from them. The enterprise system has a database of items, each of which is tagged with an emotion code. The end-user system is capable of receiving the user's emotion code from the server. The search and match engine is configured to receive the user's emotion code from the end-user system and the database item emotion code from the enterprise system so that it can retrieve a plurality of items whose emotion codes proximate the user's emotion preference.

In one embodiment, the enterprise system and the search and match engine run on the same computer system. Whereas in another embodiment, the emotion preference server and the search and match engine are hosted in the same computer system.

### DRAWINGS

### Figures

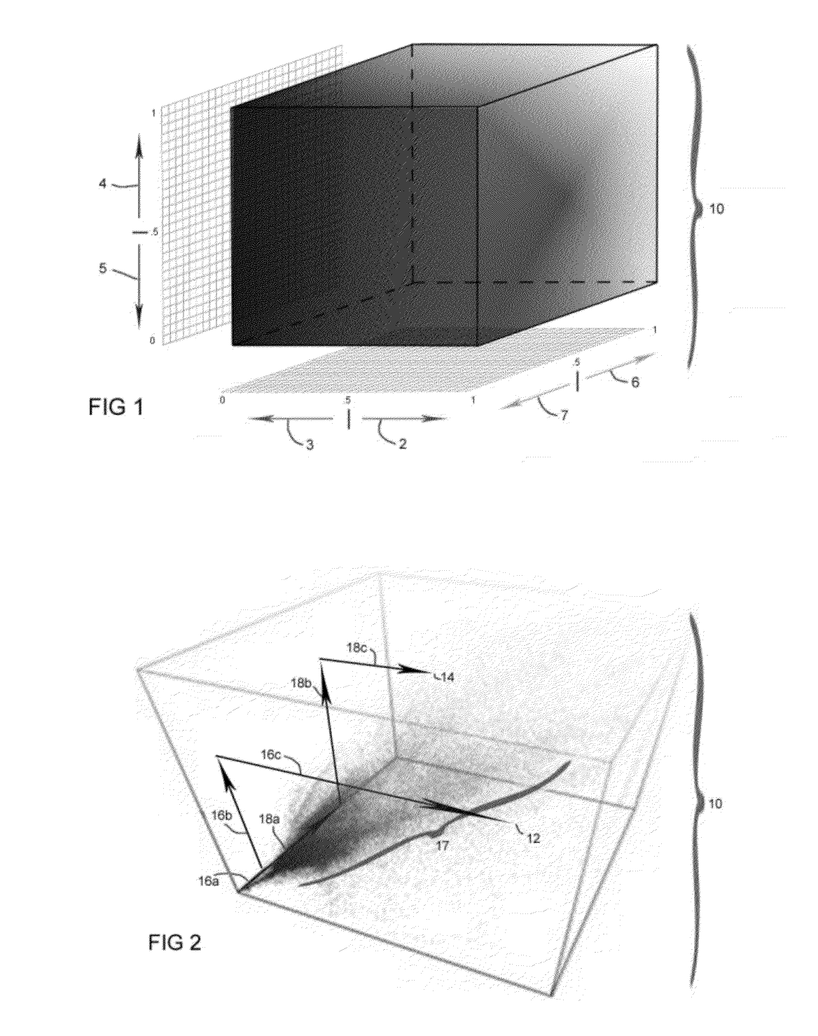

FIG. 1 is a perspective view of a three-dimensional emotion (emotion code) graph based on the RGB color model.

FIG. 2 is a perspective view of the emotion code graph which illustrates a distance calculation between a user emotion input value and a record in the emotion code graph.

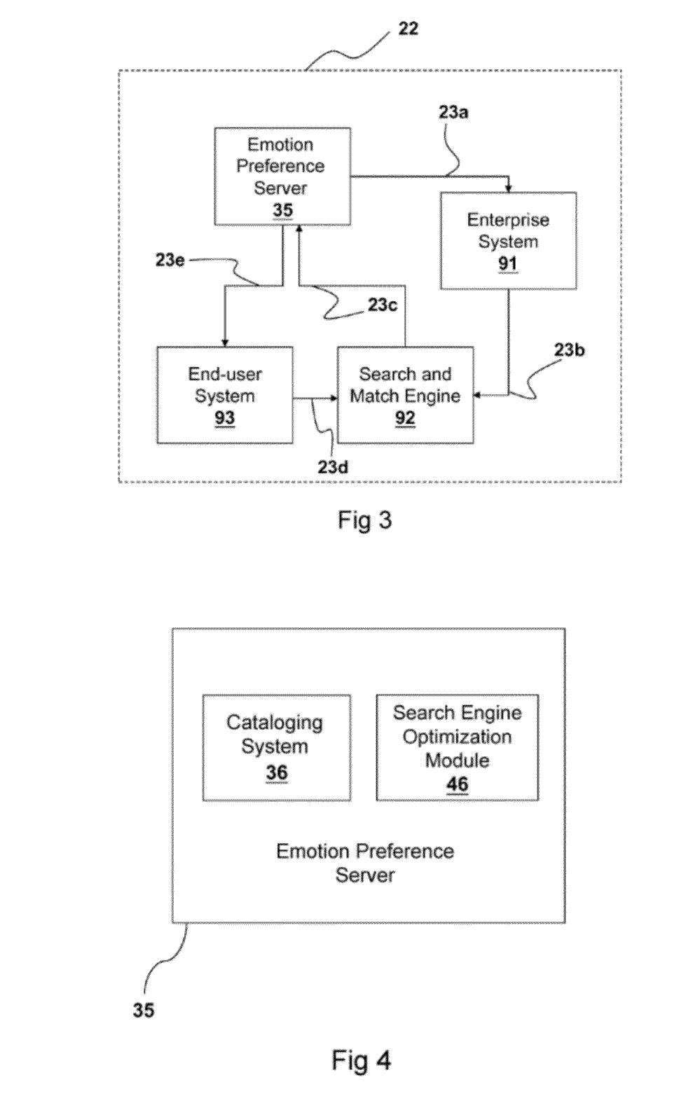

FIG. 3 is a block diagram of the computerized ideation search engine in one embodiment.

FIG. 4 is a block diagram of the emotion preference server in one embodiment.

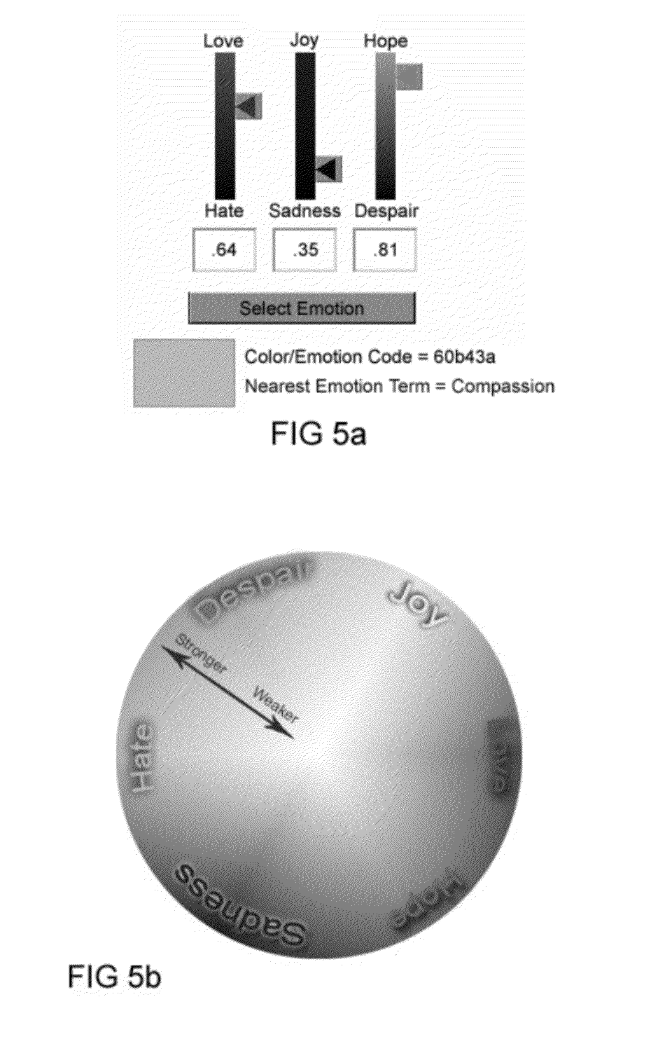

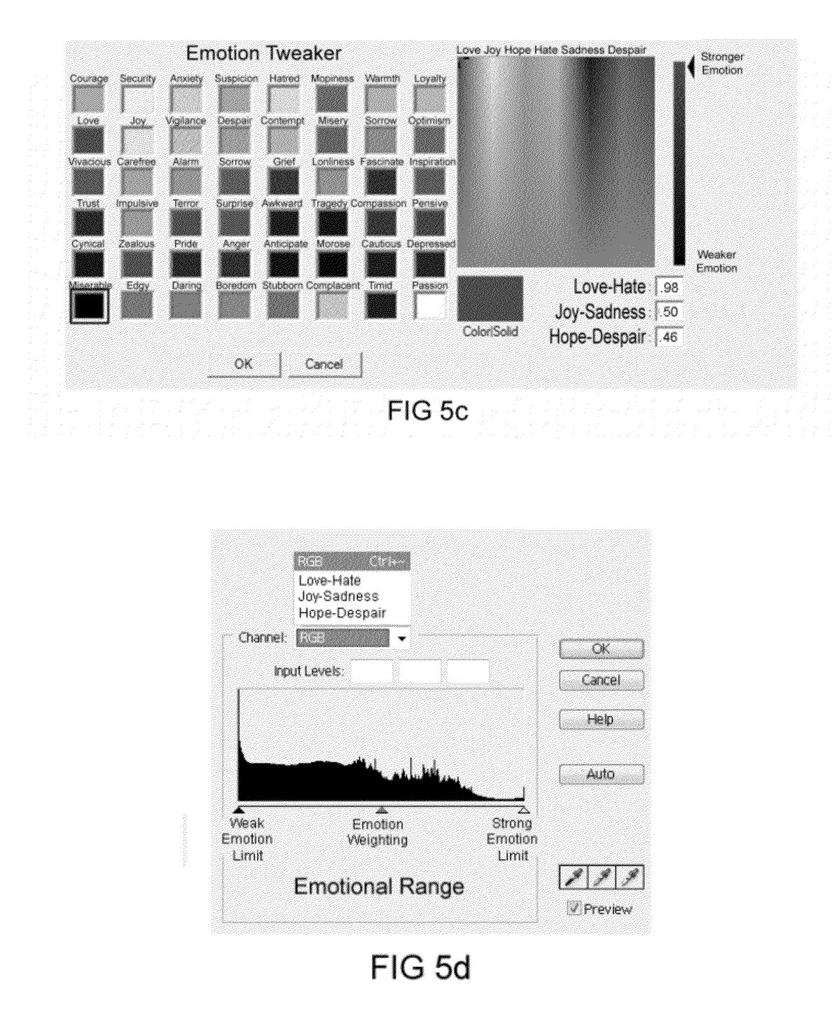

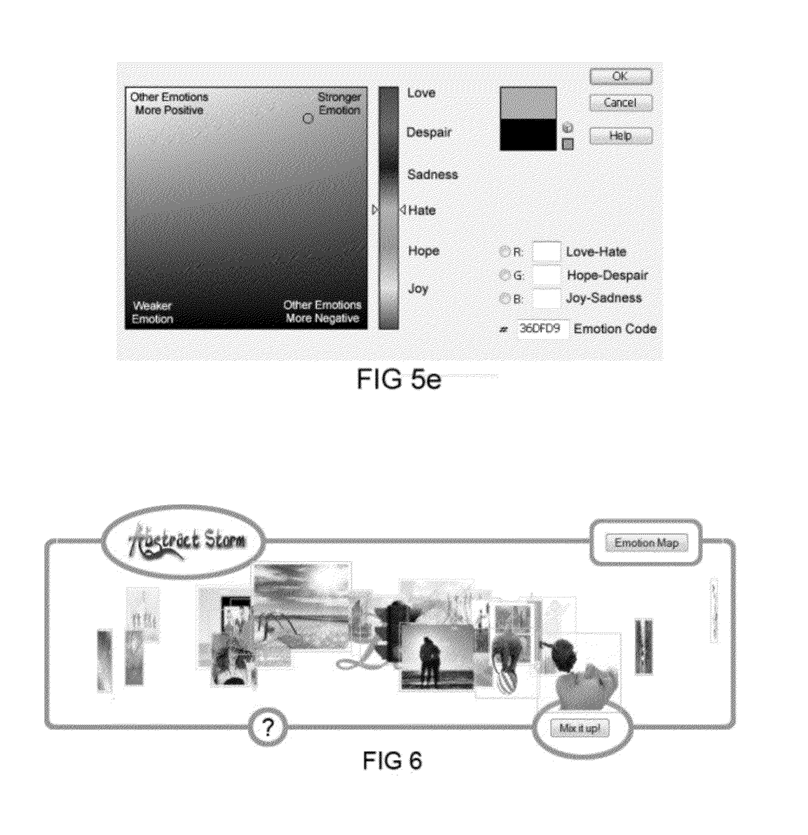

FIGS. 5a, 5b, 5c, 5d, 5e are examples of RGB analogic emotion input forms.

FIG. 6 is an example of a non-RGB analogic emotion input form.

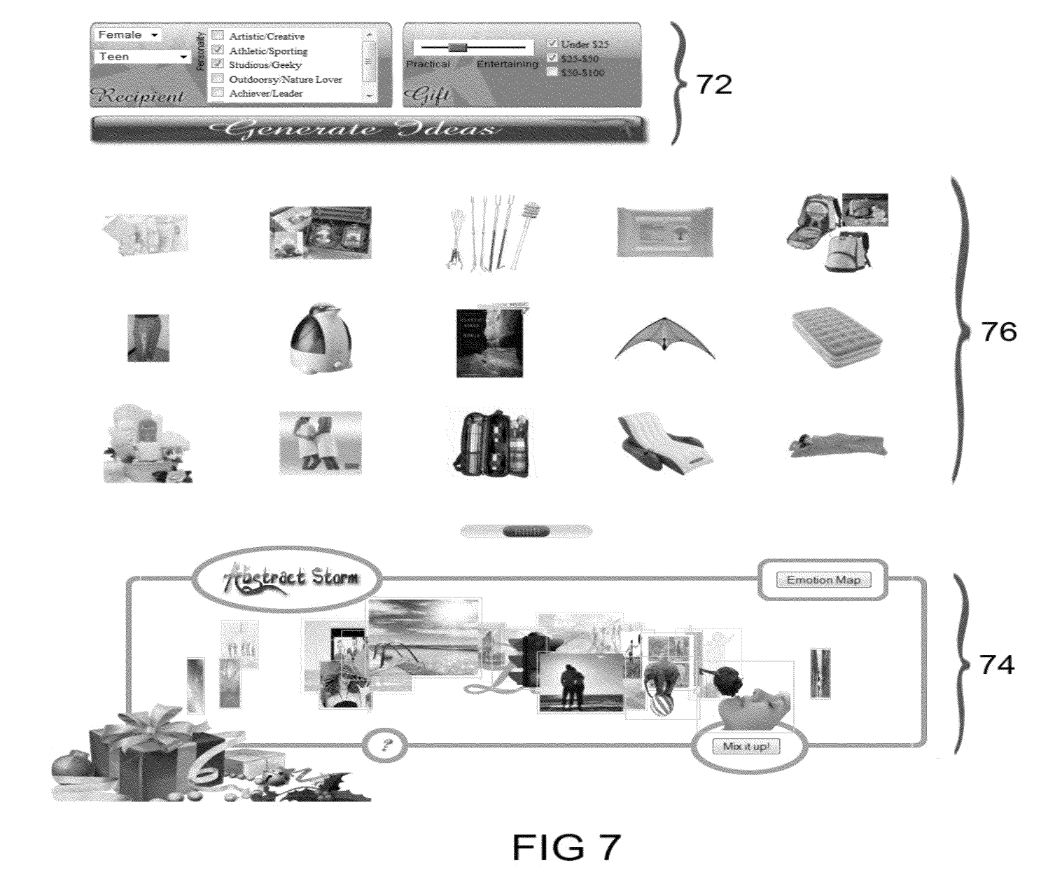

FIG. 7 is a screen shot of an example website utilizing the ideation search engine.

### DESCRIPTION OF THE PREFERRED EMBODIMENTS

Referring now to the embodiment in more detail, in FIG. 1 there is shown a three-dimensional emotion graph based on the RGB color model wherein the primary color red is assigned to love 2, green to hope 6 and blue to joy 4. Each primary emotion has a polar opposite: hate 3, despair 7, and sadness 5, respectively. Positive primary emotions are represented by values above halfway on the color spectrum and negative emotions by values below halfway. For example, on a scale between 0 and 1, 0 is black, 0.5 is middle red and 1 is pure red. When red represents love/hate, values above 0.5 represent love and below represent hate. Furthermore, intensity of emotion is represented by proximity to the upper and lower limits. So, stronger hate is represented by values closer to zero, weaker hate by values closer to and below 0.5, weaker love is represented by values above and closer to 0.5, stronger love by values closer to 1. The resulting emotional code for an entity is the same as that of a color. We will refer to the resulting emotional valuation as an emotion code. This can be expressed in any format, such as decimal (e.g.: 0.18, 0.53, 1.0) or hexadecimal (e.g.: ADFF2F), and with any range of values.

To attain a system for modeling emotion states, the present invention includes (a) an emotion code graph 10 or three-dimensional emotion graph 10 that makes it possible (b) to convert between emotion code values and their respective emotion terms, (c) a formula for calculating the distance between emotion code values and other emotion code values, and between an emotion code value and the closest emotion terms that match it, (d) a method for calculating the average emotional response of a group to given tangible aspects of an entity, thereby permitting the assignment of an emotion code and single emotion term that best represents the those aspects of the entity.

### The Distance Calculator

The distance calculator estimates the similarity vs. difference between a user input emotion code value, the emotion code values assigned to database entities, and the emotion code values of emotion terms. It has four input values: J, L, H numeric values plus an emotion term string. The output is the distance in emotion space between the specific J, L, and H values that are input and the exact location of the emotion term in emotion space. The distance is also expressed as a percentage figure. In sum, the distance calculator converts the four inputs into the two outputs.

As shown in FIG. 2, distance is calculated between said input emotion code 12 value and a record 14 (emotion term or database entity) in the emotion code graph 10 according to the following formula, where J 16b, L 16c, H 16a are the user input emotion code values, and Jᵢ 18b, Lᵢ 18c, Hᵢ 18a are the emotion code values for record i:

√(J−Jᵢ)²+(L−Lᵢ)²+(H−Hᵢ)²

The benefit of the distance formula (and related percentage figure) is that it allows one to ascertain how “far” a certain user input emotion preference is from any given emotion term and from database entities tagged with emotion code values 17. Assume, for example, that one goal of a system is to measure the similarity between a user input emotion code and the emotion codes of the various items of a product catalog. The distance is computed between the user input emotion code value, the emotion code values for all the items of a database and the emotion code values for all the emotion terms in the emotion code table. This allows for the return of the nearest emotion term to the user's emotion preference. The items of a database can then be returned as ideation search engine results based on distance from the user's emotion preference. Or, a tolerance level for emotional relevancy can be set, and the results within that tolerance returned according to any sort order that the user specifies. The process also works in reverse, allowing the user a string based input form or a list of emotion terms to express emotion preference, then basing results on that emotion term's emotion code value.

### The Emotion Term/Emotion Code Converter

The emotion term/emotion code converter has an emotion term as an input, and three output values representing varying degrees of joy/sadness, love/hate, and hope/despair. Or vise versa, with the three emotion code values as input and an emotion term as output. The table allows one to convert the inputs (emotion terms) to outputs (emotion codes) and vise versa. Converting an emotion string to its emotion code value is performed by simple lookup function on the emotion code Table where the key is the emotion term string and the results are the J, L and H values. If the Table is implemented in SQL, the statement would take the form: Select J, L, H, where EmotionName=<label>.

If the table is implemented in a procedural or object oriented language, the table lookup is performed either by simple iteration through all table records, or if higher performance is desired, by selecting records that have been pre-sorted using a standard Quicksort or Hash Table algorithm.

### The Emotion Code Averager

The emotion code averager is a system and method that can have from one to an infinite number of inputs. Each input consists of 3 numeric values: J, L, H. The outputs are Average J (i.e., average of all the J values), Average L, and Average H. In effect, the emotion code averager is used to identify the average emotional response of a group of individuals to any stimulus. Specifically, to average emotion code values, one averages all of the J values from a group of respondents who have reported their emotional reaction to a specific entity. Then one repeats this separately by averaging all their L values for the same entity. Next, one repeats this separately by averaging all their H values for that same entity. Once average values for a group are identified, these values become the emotion code for that entity, and the emotion term/emotion code converter is used to assign an emotion term. Alternatively, instead of averages, median J, median L, and median H scores may be used in some cases where there is a concern about a handful of very extreme emotion code scores resulting in excessive error in calculations of averages. Also alternatively, clusters of emotion code input values could be used to define a volumetric perimeter which would be associated with the entity or emotion term.

Tagging Database Entities and Emotion Terms with Emotion Codes

The emotion code chart of emotions provides precise measures of 320 of the most common emotion terms by referencing each emotion term to three fundamental dimensions of emotion response, e.g.: Joy-Sadness (J), Love-Hate (L), Hope-Despair (H). The emotion code table of emotions contains 320 rows of data and is a database of information consisting of four fields. The first field represents an emotion term. The second field, labeled “J”, is numeric, with values that can range from 0 to 1, and indicates the degree of Joy vs. Sadness that is associated with the emotion term given in the first field. The third field, labeled “L”, is numeric and can range from 0 to 1, and indicates the degree of Love vs. Hate that is associated with the emotion term given in the first field. The fourth field, labeled “H”, is numeric and can range from 0 to 1, and indicates the degree of Hope vs. Despair that is associated with the emotion term given in the first field.

The 320 emotion code emotion terms are derived from the PAD scales of Mehrabian and Russell (1974). To obtain emotion code values for a single emotion term, a plurality of subjects are each individually presented the single emotion term together with an emotion input form (see Emotion Input Form and Processing below) and are instructed to apply levels of joy/sadness, love/hate and hope/despair, resulting in an emotion code. Levels for each are averaged using the emotion code averager. This yields consensus or group-based emotion code values for the emotion term. Emotion code values for database items and any other emotion term not contained among the 320 PAD terms can also be obtained by using the same process.

According to another aspect of the present invention, in FIG. 3 there is shown an ideation search engine 22 comprising multiple subsystems, which include a computerized emotion preference server 35, at least one enterprise system 91, at least one search and match engine 92 and at least one end-user system 93. These subsystems are each connected to the computerized emotion preference server 35 via different data communication channels 23a, 23b, 23c, 23d and 23e. These data communication channels establish point to point data path between the two parties. This can be done either through a private communication network, a public network such as the Internet, or a virtual private network (VPN). It may traverse one or more local area network (LAN), metropolitan area network (MAN), wide area network (WAN), or a combination thereof. Each of such networks may be implemented using leased lines, optical fiber, wireless technologies, or other networking technologists.

In FIG. 4, the internal structure of the computerized emotion preference server 35 is revealed. It further comprise an emotion preference cataloging system 36 that sends an emotion input form to the user, collects and categorizes the input results and assigns an emotion code, and a search engine optimization module 46. This module can be embedded to the search and match engine 92 so that the latter can make use of the emotion code to retrieve items that closely matches user's emotional preference.

In one specific example of the ideation search engine 22, the user is a consumer, the enterprise system is an online shopping site, and the search and match engine is provided by a third party commerce system. The consumer, through the end-user system 91, connects to the commerce system hosting the search and match engine 92 via the data 35 communication path 23d; and the merchandiser makes use of the enterprise system 91 to offer their product or service information to the commerce system via another data communication path 23b. Through the commerce system, the consumer can select what product or service to purchase. As mentioned before, each product or service can be tagged with an emotion code. When the consumer also reveals their emotion preference (emotion code) to the commerce system, the commerce system can select those products from the merchandiser's enterprise system 91 that proximate it, thus providing the consumer with the most relevant products.

### Emotion Input Form and Processing

An emotion preference cataloging system sends an emotion input form to the user, collects and categorizes the input results and assigns an emotion code. The form comprises any means of allowing the user to manipulate levels of the primary emotions Joy/Sadness, Love/Hate and Hope/Despair (JLH). Because of the analogy of the Red, Green and Blue (RGB) color model, the form can benefit from the many kinds of color manipulation forms common to graphic design. In the preferred embodiment, the emotion input form is displayed on the web browser of the user's computing device. The following figures show just a few examples of potential emotion input forms. Note that many of these are graphic design color manipulation tools that have integrated the emotion analogy.

FIG. 5a shows one example of an emotion input form whereby the user has direct input control over each primary emotion J, L and H. Output consists of an emotion code and its nearest emotion term on the emotion code graph.

FIG. 5b shows a two-dimensional representation of the emotion code graph in the form of a circular color map. The user is instructed to find the most prevalent mixture of emotions, with stronger emotions toward the saturated outer circle and weaker emotions in the middle, and then to click on the area of the map that most proximates their emotional preference. The advantage of this input method is that it's simple and intuitive; the disadvantage is in the fact that it is two-dimensional and only adjacent emotions can be mixed; therefore it does not represent the entire gamut of emotions.

FIGS. 5c and 5e shows an emotion fine-tuner or tweaker. Here is an example of how emotion terms can be used in conjunction with a color manipulation tool. The user is instructed to find an emotion term that most closely resembles their emotion preference, then allowed to fine-tune it so that they may pinpoint emotional relevancy.

FIG. 5d shows a variation of an RGB levels tool amended to present the emotion analogy. As can be seen, the tool allows the user to manually control the emotional range of search engine matches to their query. They can individually control the range of each primary emotion, setting strong and weak limits and weighting to specify which part of the range is most prevalent.

FIG. 6 shows a non-RGB analogic emotion input form. The input form uses mouse-clickable abstract impressionist images that represent coordinates on the three-dimensional emotion code graph so that when the user clicks on a particular image, the web-browser detects the user's emotion preference. The user is instructed that the images are not logical and that they are to select an image that “feels” right. Each image is tagged with an emotion code according to the same process as “Tagging Database Items” previously discussed.

A form may also be entirely text-based. This kind of survey form is to record the factual and demographic information about the users such as their sex, age range, income level and the like. An important aspect of the present invention is that the generation of ideas requires both factual and emotional input. Hence in a typical input document, the input forms comprise both pure text-based forms and emotion input forms (see example website below).

### Enterprise System 91

The merchandiser or other service providers need to manually tag their products or services with emotion codes. The user interface of the emotion code tagger is the same as the emotion input forms as previously illustrated.

### Search and Match Engine 92

As mentioned previously, the emotion codes can be used as a universal code by both the consumers and the merchandisers. The consumer can use this code to express their emotional preference while the merchandisers can segment their products or services according to this code.

In a traditional online shopping site, a consumer visiting the site will typically enter a few keywords on what they want, and a search engine at this site will search the product or service catalog and display a plurality of choices for the consumer to select. But what if the user's mind is blank and they are wanting to generate relevant ideas? The user's emotions are used for this purpose. The search and match engine 92 can incorporate the search engine optimization module 46 from the computerized emotion preference server 36 so that it can make use of the universal emotion code to generate the most proximate products or services to the user's emotional preference.

In a specific example, a consumer uses a web browser available at his end-user system 93 to visit an online commerce system that is equipped with a search and match engine 92. The commerce system, in turn, receives a product and service catalog from the enterprise system 91 of a gift store. In this case, each gift item is tagged with an emotion code.

FIG. 7 is an illustrative example of the screen shot when the consumer first enters the aforementioned online commerce site. The user needs to input their vital statistics in the text based forms 72 and their emotional preference in the emotion input form 74. At this stage the search engine returns a set of items 76 with the closest emotional relevance to the consumer's emotion code, thus accomplishing ideation. As can be seen, the returned products vary widely in all aspects except the proximity of their emotion codes. Therefore, the consumer does not need to specify a search string with detailed textual description, but instead presents their emotional preference.

Behind the scenes, the search engine optimization module that is embedded to the search and match engine 92 of the commerce system uses the consumer's emotion code to define a peripheral region defined by the website designer. If the setting is broadest, the peripheral region is set to be wider, and the commerce system 92 chooses product or service items from its catalog from that wider peripheral region. Hence the selected items will have more diverse emotion profiles. When the setting is narrowest, the peripheral region becomes smaller; hence the items selected will be more emotionally homogenous.

While the aforementioned paragraphs use an online gift shopping scenario to teach how the emotion code can be used to overcome the limitations of the traditional search engines, the underlining invention can be applied to encompass many other scenarios. Hence, instead of a consumer searching the products or services of an online site, the emotion preference system can be generalized to retrieving, searching or matching operations between two entities, where an entity can be a user, a product, or a service. In one such scenario, the ideation search engine may be configured for a search entity to find a list of database entities that have similar emotion codes. When both the search and the database entities are human beings, the system matches people with a similar emotional preference.

In addition, while an eCommerce scenario is given here, the emotional preference system can actually be applied to much broader areas—between an information seeker and an information provider, where the latter can be a government institution, a public library, or any other similar organizations. When all the entities are tagged with emotion codes, this code becomes a universal, machine readable language that codifies human emotion.

### Advantages

The embodiment improves on the PAD Emotion Scale in several ways. Instead of the primary factors being pleasure, arousal, and dominance (PAD), they are joy, love, and hope (JLH). One disadvantage of PAD is that it is intended for use by trained professionals and therefore is not directly accessible to the average search engine user. The JLH system removes the necessity of an intermediate step between an emotion expression means (like a lengthy cumbersome survey) and a standardized emotion classification system (like PAD), because the user can interface directly with the classification system (i.e., with joy, sadness, love, hate, hope and despair). And because JLH is directly analogous to RGB, many more communication methods (emotion input forms) are made possible than without the sensory benefit of color.

A major disadvantage of the prior art survey emotion profile is that it does not follow the proven search engine paradigm of a simple input form, instead asking the user to spend time going through the cumbersome steps of filling out a multipaged survey. Another disadvantage is that the user may feel branded with an intangible and mysterious emotion rating via a browser cookie—a black cloud of emotional judgment hanging over them. By allowing them to input their emotional preference directly through the RGB color analogy, to interface directly with the emotion classification system, there is no mystery to the process of emotion valuation. The user knows exactly and immediately the terms of their emotion selection and has the ability to change that selection conveniently and at will. In other words, the simple emotion input form follows the proven paradigm of conventional search engines.

Another advantage of using the analogy of color is the vast and powerful prior development of color selection and manipulation tools in the world of graphic design. The same tools can be used to communicate emotion. They can be used both for the application of emotion codes to database items (emotion tagging) and for the communication of emotion by the user (an emotion input form). FIGS. 5a, 5b, 5c, 5d and 5e illustrate several examples of software color input tools which can be used to input emotion using the JLH system.

Another advantage over prior art is that these tools for color selection are not the only way of accessing emotional values. Lingual secondary emotions (words such as pessimistic, depressing, silly, comforting, etc.) can possess coordinates in the volumetric graph, thereby allowing the functionality to extend to spoken and written language. Thus, string type input forms could be used for user emotion expression. Also, the embodiment doesn't have to solely depend on metadata and the pretagging of items in a database for its functionality. It is possible to create a system for correlating emotion codes and their nearest lingual emotion terms to the instances of related keywords that reside in Internet-based content. This is one of the great benefits of a standardized emotion valuation system: functionality can extend across several disciplines of human expression and sensory experience.

Finally, the embodiment encompasses all research areas of affective computing. It externally constructs emotion valuation as informational units, and it does so culturally and interactionally. As both an interface paradigm and an evaluative strategy, it doesn't try to make the computer “understand” emotion so much as it encourages the user's awareness, understanding and experience of their own emotions.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A system for classifying human emotion comprising a three-dimensional graph whose axes comprise intensity levels of three primary emotions and their polar opposites.

2. The system of claim 1, wherein all axes converge at one point comprising the maximum intensity of all three negative primary emotions, whereby the midpoint of each axis is equal to the lack of emotion, and whereby the opposite end of each axis comprises the maximum intensity of positive emotion.

3. The system of claim 1, wherein the three said primary emotions and their polar opposites are chosen from a list as defined by prominent emotion theorists, including but not limited to: happiness, sadness, acceptance, anger, anticipation, disgust, despair, surprise, joy, aversion, courage, desire, hate, hope, love, anxiety, interest, contempt, distress, shame, dejection, guilt, interest, wonder, sorrow, rage, terror, pain, and pleasure.

4. The system of claim 1, wherein the primary emotions are chosen so that no combination of any two can be used to produce the third.

5. A method of codifying human emotion into a machine-readable language by a computer application comprising the steps of:
(a) having said three-dimensional emotion graph whose axes comprise intensity levels of three primary emotions and their polar opposites, such as joy/sadness, love/hate, hope/despair;
(b) obtaining human emotion preferences through capturing a user's response while they make selections from one or more input forms in which they choose an intensity level of said three primary emotions and their polar opposites, said input form being of any format that allows the user to control, directly or indirectly, intensity levels of said three primary emotions and their polar opposites;
(c) assigning an emotion code based on the user's input in said machine-readable language and resulting in a coordinate on said three-dimensional emotion graph; wherein said user's emotion preference may be digitally conveyed to a second computer application; and wherein said second computer application is able to adapt its operation based on the interpretation of said emotion code.

6. The method of claim 5 further comprising associating said emotion codes to a plurality of entities, such as the contents of a product database; said associating step comprising:
(a) obtaining a multimedia object representative of said entity;
(b) choosing a plurality of tangible aspects of said entity, possibly including, but not limited to, “form” and “function”;
(c) displaying said plurality of representative multimedia objects along with said emotion input forms on a display device for a plurality of users;
(d) requesting said users to create said emotion code for said tangible aspects of said entity by using said input form;
(e) averaging the resulting said emotion codes for each said tangible aspect of said entity;
(f) assigning said emotion codes to said tangible aspects of said entity.

7. The method of claim 5, wherein a plurality of multimedia objects are associated with emotion codes using the same associating method as claim 6; said multimedia objects being representative of coordinates on said three-dimensional emotion graph; thereby allowing said user to convey an emotion by selecting from said multimedia objects rather than said three primary emotions.

8. The method of claim 5 further comprising returning items from a search operation using said machine-readable emotion code; said emotion code generated by a user interfacing with an emotion input form; the selection revealing said user's emotion preferences; said method comprising the steps of:
(a) presenting the user with one or more said emotion input forms;
(b) using the resulting emotion code coordinates on a three-dimensional emotion graph to define a peripheral region centered around said coordinates;
(c) connecting to a database that comprises a plurality of database entities that are associated with said emotion codes;
(d) retrieving a plurality of matching database entities; each of said database entities having its emotion code falling within said peripheral region; and
(e) presenting said plurality of database entities to said user.

9. A computer system for codifying human emotion into a machine readable language, comprising:
(a) an emotion preference server configured to:
I. capture user emotion preferences with one or more emotion input forms,
II. generate emotion codes from said emotion preferences, and
III. generate emotion terms from said emotion codes;
(b) an enterprise system capable of assigning emotion codes to a plurality of database entities;
(c) an end-user system capable of displaying interactive emotion input forms resulting in the output of one or more emotion codes; and
(d) a search and match engine configured to receive said user emotion codes from said end-user system and said entity emotion code from said enterprise system; said search and match engine further configured to retrieve a plurality of said entities which proximate said user emotion codes.

10. The computer system in claim 9, wherein said emotion preference server further comprises:
(a) a cataloging system with a table of a plurality of emotion terms, each of which possesses a coordinate or cluster of coordinates on said three-dimensional emotion graph using the same associating method as claim 6; thereby translating between emotion codes and their lingual equivalents.
(b) a search engine optimization system for providing said search and match engine the capability of matching using said emotion codes.

11. The computer system of claim 9, wherein said enterprise system and said search and match engine run on the same computer system.

12. The computer system of claim 9, wherein said emotion preference server and said search and match engine run on the same computer system.
